(19) United States
(12) Patent Application Publication
(10) Pub. No.: US 2008/0152549 A1
(43) Pub. Date: Jun. 26, 2008

(54) Preheating process for FCC regenerator

(76) Inventors: Gavin P. Towler, Inverness, IL (US); Douglas N. Rundell, Glen Ellyn, IL (US)

Correspondence Address: BRINKS HOFER GILSON & LIONE, P.O. BOX 10395, CHICAGO, IL, 60610, US

(21) Appl. No.: 11/643,734

(22) Filed: Dec. 21, 2006

(51) Int. Cl. B01J 8/18

(52) U.S. Cl. 422/139; 422/187; 502/56

(57) ABSTRACT

A preheating process is provided for a regenerator in a fluid catalytic cracking system having a reactor and a regenerator at oxidative conditions. A first gas stream containing oxygen at an inlet pressure is compressed to a pressure of at least about 10 atm to produce a compressed gas stream. A second gas stream containing a fuel source is combusted with the compressed gas stream to produce a heated gas stream. The heated gas stream is expanded to a predetermined low pressure to produce a feed gas stream. The feed gas stream is introduced into the regenerator in the fluidized catalytic cracking system.

### THE NAMES OF THE PARTIES TO A JOINT RESEARCH AGREEMENT

This application is the result of a joint research agreement between UOP, LLC and BP America, Inc.

### BACKGROUND

The present invention relates to a preheating process for a regenerator in a fluid catalytic cracking system.

The fluidized catalytic cracking of hydrocarbons is the mainstay process for the production of gasoline and light hydrocarbon products from heavy hydrocarbon charge stocks such as vacuum gas oils or residual feeds. Large hydrocarbon molecules associated with the heavy hydrocarbon feed are cracked to break the large hydrocarbon chains thereby producing lighter hydrocarbons. These lighter hydrocarbons are recovered as product and can be used directly or further processed to raise the octane barrel yield relative to the heavy hydrocarbon feed.

The basic equipment or apparatus for the fluidized catalytic cracking of hydrocarbons has been in existence since the early 1940's. The basic components of the FCC process include a reactor, a regenerator, and a catalyst stripper. The reactor includes a contact zone where the hydrocarbon feed is contacted with a particulate catalyst and a separation zone where product vapors from the cracking reaction are separated from the catalyst. Further product separation takes place in a catalyst stripper that receives catalyst from the separation zone and removes entrained hydrocarbons from the catalyst by counter-current contact with steam or another stripping medium.

The FCC process is carried out by contacting the starting material—generally vacuum gas oil, reduced crude, or another source of relatively high boiling hydrocarbons—with a catalyst made up of a finely divided or particulate solid material. The catalyst is transported like a fluid by passing gas or vapor through it at sufficient velocity to produce a desired regime of fluid transport. Contact of the oil with the fluidized material catalyzes the cracking reaction. The cracking reaction deposits coke on the catalyst. Coke is comprised of hydrogen and carbon and can include other materials in trace quantities such as sulfur and metals that enter the process with the starting material. Coke interferes with the catalytic activity of the catalyst by blocking active sites on the catalyst surface where the cracking reactions take place. Catalyst is traditionally transferred from the stripper to a regenerator for purposes of removing the coke by oxidation with an oxygen-containing gas. An inventory of catalyst having a reduced coke content relative to the catalyst in the stripper, hereinafter referred to as regenerated catalyst, is collected for return to the reaction zone. Oxidizing the coke from the catalyst surface releases a large amount of heat, a portion of which escapes the regenerator with gaseous products of coke oxidation generally referred to as flue gas. The balance of the heat leaves the regenerator with the regenerated catalyst. The fluidized catalyst is continuously circulated from the reaction zone to the regeneration zone and then again to the reaction zone. The fluidized catalyst, as well as providing a catalytic function, acts as a vehicle for the transfer of heat from zone to zone. Catalyst exiting the reaction zone is spoken of as being spent, i.e., partially deactivated by the deposition of coke upon the catalyst. Specific details of the various contact zones, regeneration zones, and stripping zones along with arrangements for conveying the catalyst between the various zones are well known to those skilled in the art.

Refining companies are under increased pressure to reduce CO₂ emissions as a result of carbon tax legislation and other drivers such as a desire to demonstrate long-term sustainability. Roughly 15-25% of refinery CO₂ emissions are caused by the burning of catalyst coke in the FCC regenerator. Thus, there is a need to provide a way to reduce the carbon dioxide emissions of a fluid catalytic cracking unit.

### BRIEF SUMMARY

Embodiments of the present invention generally provide systems and methods of reducing carbon dioxide emissions in fluid catalytic cracking units having a reactor and a regenerator at oxidative conditions.

In one aspect, a preheating process is provided for a regenerator in a fluid catalytic cracking system having a reactor and a regenerator at oxidative conditions. A first gas stream containing oxygen at an inlet pressure is compressed to a pressure of at least about 10 atm to produce a compressed gas stream. A second stream containing a fuel source is combusted with the compressed gas stream to produce a heated gas stream. The heated gas stream is expanded to a predetermined low pressure to produce a feed gas stream. The feed gas stream is introduced into the regenerator in the fluidized catalytic cracking system.

In another aspect, a preheating system for a regenerator in a fluidized catalytic cracking system includes a first gas containing oxygen at an inlet pressure and a compressor in fluid communication with the first gas and configured to compress the first gas to a pressure of at least about 10 atm. The system also includes a second gas containing a fuel source and a combustor in fluid communication with the compressor and the second gas and configured to combust the second gas with the first gas to produce a heated gas. An expander is in fluid communication with the compressor and configured to expand the heated gas to a predetermined low pressure to produce a feed gas and electricity. A regenerator for regenerating spent catalyst is in fluid communication with the expander and configured to receive the feed gas to burn coke from the spent catalyst.

The foregoing and other features and advantages of the present invention will become apparent from the following detailed description of the presently preferred embodiments, when read in conjunction with the accompanying examples.

### BRIEF DESCRIPTION OF THE DRAWING

FIG. 1 shows an embodiment of an FCC regenerator including an embodiment of a preheating process.

### DETAILED DESCRIPTION OF THE PREFERRED EMBODIMENTS

The present invention will now be further described. In the following passages, different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

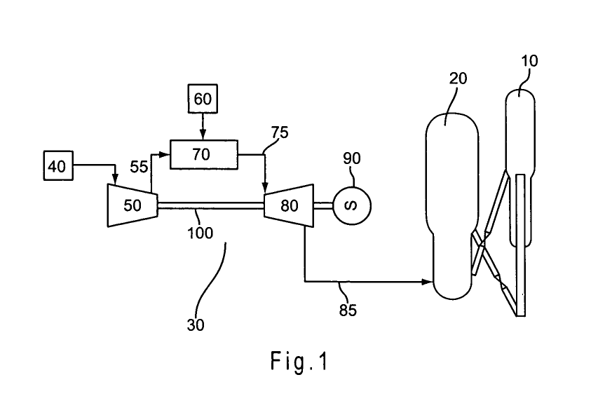

FIG. 1 shows a schematic of a preheating process for a regenerator in a fluid catalytic cracking system. The FCC system includes a reactor 10 and a regenerator 20. The reactor 10 cracks a hydrocarbon feed into simpler molecules through contact with a catalyst. The regenerator 20 is preferably running at oxidative conditions, i.e. where the catalyst is regenerated by removing coke by oxidation with an oxygen-containing gas. The air supply for the regenerator is supplied by a preheating system 30. The preheating system 30 includes a compressor 50, a combustor 70, and an expander 80. The components of the preheating system 30 are preferably provided in a gas turbine engine.

The use of gas turbine engines for power generation is known in the refinery industry. Many refineries use cogeneration plants to supply electric power and steam to the refinery. In a cogeneration plant the exhaust gas from a gas turbine engine is used to raise steam in a waste-heat boiler. In some cases, the exhaust gas is secondary fired using a duct burner. Secondary firing is possible because gas turbine engines typically operate with a large excess of air (2 to 3 times the stochiometric ratio) compared to a boiler or furnace (1.1 to 1.2 times stochiometric) and hence there is significant residual oxygen in the turbine exhaust. In the present system, a gas turbine is used to preheat the feed gas to the regenerator.

A gas turbine, also called a combustion turbine, is a rotary engine that extracts energy from a flow of combustion gas. It includes an upstream compressor coupled to a downstream turbine, and a combustion chamber in-between. Energy is generated where air or other oxygen-containing gas is mixed with fuel and ignited in the combustor. Combustion increases the temperature, velocity and volume of the gas flow. The exhaust gas flow is generally directed through a nozzle over the blades of a turbine, spinning the turbine to power the compressor and provide additional power. As with all cyclic heat engines, higher combustion temperature means greater efficiency. The limiting factor is generally the ability of the steel, ceramic, or other materials that make up the engine to withstand high shear from rotation at high speed and high temperature.

The components of preheating system 30 and its relationship with the FCC system will now be described. A compressor 50 is in fluid communication with a gas source 40 containing oxygen. A combustor 70 is in fluid communication with the compressor 50 and a fuel source 60. An expander 80 is in fluid communication with the compressor 50 and configured to expand the heated gas. The feed gas is then fed to the regenerator 20. The regenerator 20 regenerates spent catalyst and burns coke from the spent catalyst.

The gas stream 40 feeding the compressor 50 includes oxygen. The gas stream 40 preferably contains air, and thus also includes nitrogen and other gases. The gas stream 40 is introduced into the compressor 50 at an inlet pressure. The inlet pressure 40 may be around atmospheric pressure.

The compressor 50 compresses the gas stream 40 from the inlet pressure to a second pressure to produce a compressed gas stream 55. The ratio of the pressure of the compressed gas to the inlet pressure is preferably between about 10:1 and about 50:1, more preferably between about 15:1 and about 30:1, and most preferably between about 20:1 and about 30:1. The second pressure is preferably at least about 10 atm, and preferably between about 15 and about 30 atm. Any suitable compressor 50 may be used.

The compressed gas stream 55 is then introduced into a combustor 70. A second stream 60 containing a fuel source is also introduced into the combustor 70. The fuel source may be natural gas, dry gas from the fluidized catalytic cracking unit, mixtures thereof, or any other suitable fuel source. Dry gas generally includes hydrogen, methane, ethane, and possibly higher gases such as ethylene. The fuel source and the compressed gas stream are combusted to produce a heated gas stream 75. The ratio of oxygen to fuel in the combustor 70 is preferably between about 1.5 and 5 times the stochiometric ratio, more preferably between about 2 and 3 times the stochiometric ratio, wherein the excess oxygen in the exhaust gas is then used to oxidize the coke in the regenerator. The heated gas stream 75 preferably has a temperature between about 1000° C. and about 1500° C. In one embodiment, the temperature of the heated gas stream is at least about 1200° C. In another embodiment, the temperature of the heated gas stream is at least about 1400° C.

The heated gas stream 75 is then introduced into an expander 80. The expander 80 expands the heated gas stream to a predetermined low pressure to produce a feed gas stream 85. The predetermined low pressure is preferably between about 20 and 30 psig. The expansion of the heated gas stream may also produce energy, such as electricity, that may be used in another process. Part of the energy is used to power the compressor 50 and the rest is a power source. The amount of energy or electricity produced is typically about 20 to 50% of the heat of combustion of the fuel fired. The amount of energy or electricity produced is preferably at least about 20%, and more preferably at least about 35%, of the heat of combustion of the fuel fired. For example, in one configuration, 1 Kilowatt hour of electricity is produced per 9,500 BTU of fuel combusted, or about 36% of the heat of combustion. The specific relationship between fuel consumption and energy produced will depend upon design features of the turbine and expander such as maximum combustor operating temperature. The turbine produces electricity at high efficiency by operating at the high temperature of the gas. The efficiency of the process of the present invention stems from the fact that the heat from the combustion process is not wasted but is instead supplied to the regenerator.

The regenerator feed gas stream 85 typically includes between 10% and 15% oxygen and preferably has a temperature of at least about 300° C. In one embodiment, the temperature of the feed gas stream 85 is at least about 400° C. In another embodiment, the temperature of the feed gas stream 85 is at least about 500° C. In another embodiment, the temperature of the feed gas stream 85 is at least about 600° C. The feed gas stream 85 is typically between about 20 and 30 psig.

After expansion, the feed gas stream 85 is introduced to the regenerator 20 in the fluidized catalytic cracking system to burn coke from spent catalyst in the regenerator under oxidative conditions. Catalyst enters a combustion zone in the regenerator. The combustion zone is a fast fluidized zone through which the feed gas stream 85 transports catalyst while initiating coke combustion. The feed gas stream 85 enters the combustor through a distributor which distributes the gas over the transverse cross-section of combustor. The upward flow of gas through combustor creates the fast fluidized conditions by transporting the catalyst upwardly at a velocity of between 2 to 25 ft/sec and at a density in a range of from 1 to 34 lbs/ft³. Typical temperatures in the combustion zone range from 650° C. to 800° C. Temperatures within the combustion zone can be raised by initiating or increasing circulation of hot regenerated catalyst into the combustion zone via a recirculation conduit. Temperatures within the combustion zone can be lowered by passing cooled regenerated catalyst into the combustor from a catalyst cooler.

The present invention may be used with any FCC process, the general operation of which is well known in the art. The preheating process may also be used with an FCC process using a catalyst recycle reactor and/or a two stage regenerator, such as disclosed in U.S. Pat. Nos. 5,451,313 and 5,597,537, the contents of which are hereby incorporated by reference.

Because in the present system, the air is preheated before entering the regenerator, the amount of heat needed to raise the temperature of the air is reduced, compared to a normal FCC system. Thus, less coke needs to be burned in the regenerator. The amount of coke circulated through the regenerator can be reduced by controlling the recycle and flow rates of the catalyst between the regenerator, the reactor, and the catalyst recycle reactor (if present).

Global CO₂ emissions are reduced by the preheating process of the present invention, because the incremental electric power produced by the expander has much lower incremental CO₂ emissions than electric power generation from fossil fuels such as coal or natural gas, due to the high effective efficiency of conversion of combustion energy into electricity and subsequent downstream use of the turbine exhaust energy.

To ensure reliability of the preheating process, for example in the case of a turbine breakdown, a back-up blower may be installed to maintain a flow of air to the regenerator if the turbine is not available. The amount of coke in the regenerator may then be managed to compensate for the loss of heat input to the turbine.

### EXAMPLE

The following example of an embodiment of the invention is provided by way of explanation and illustration. Mathematical simulations were conducted to calculate the reduction of coke burned in the regenerator of an FCC system using the preheating process of the present invention (Example 1), compared to a conventional regenerator operating under the same conditions (Comparative Example). The following Table 1 illustrates the reduction in coke burn. It can be seen that the amount of coke burned in Example 1 is 21% less than the Comparative Example, thus resulting in a reduction of CO₂ emissions_{[JYI]}.

TABLE 1

| | Comparative | |
|---|---|---|
| | Example | Example 1 |
| Feed Gas to Regenerator | | |
| O₂, vol % | 21.0% | 13.5% |
| N₂, vol % | 79.1% | 86.5% |
| Gas Flow Rate, lb-mols/hr | 32,849 | 52,459 |
| Coke Burn Rate, lbs/hr | 68,865 | 54,350 |
| Enthalpy into Regenerator | | |
| Coke Burn, MM BTU/hr | 1,156 | 913 |
| Feed Gas, MM BTU/hr | 35 | 278 |
| TOTAL | 1,191 | 1,191 |
| Coke Burn Reduction | | 21% |

It should be appreciated that the methods and compositions of the present invention are capable of being incorporated in the form of a variety of embodiments, only a few of which have been illustrated and described above. The invention may be embodied in other forms without departing from its spirit or essential characteristics. It will be appreciated that the addition of some other ingredients, process steps, materials or components not specifically included will have an adverse impact on the present invention. The best mode of the invention may therefore exclude ingredients, process steps, materials or components other than those listed above for inclusion or use in the invention. However, the described embodiments are to be considered in all respects only as illustrative and not restrictive, and the scope of the invention is, therefore, indicated by the appended claims rather than by the foregoing description. All changes which come within the meaning and range of equivalency of the claims are to be embraced within their scope.

What is claimed is:

1. A preheating process for a regenerator in a fluid catalytic cracking system having a reactor and a regenerator, comprising:
compressing a first gas stream comprising oxygen at an inlet pressure to a pressure of at least about 10 atm to produce a compressed gas stream;
combusting a second stream comprising a fuel source with the compressed gas stream to produce a heated gas stream;
expanding the heated gas stream to a predetermined low pressure to produce a feed gas stream at a temperature of at least about 300° C.; and
introducing the feed gas stream to the regenerator in the fluidized catalytic cracking system, wherein the regenerator is at oxidative conditions.

2. The process of claim 1 wherein the fuel source comprises natural gas.

3. The process of claim 1 wherein the fuel source comprises dry gas from the fluidized catalytic cracking system.

4. The process of claim 1 wherein the first gas stream comprises air.

5. The process of claim 1 wherein the ratio of oxygen to fuel in the combustor is between about 1.5 and 5 times the stochiometric ratio.

6. The process of claim 1 wherein the ratio of oxygen to fuel in the combustor is between about 1 and 3 times the stochiometric ratio.

7. The method of claim 1 wherein the ratio of the pressure of the compressed gas to the inlet pressure is between about 15:1 and 30:1.

8. The method of claim 1 wherein the pressure of the compressed gas stream is between about 15 and 30 atm.

9. The method of claim 1 wherein the temperature of the feed gas stream is at least about 400° C.

10. The method of claim 1 wherein the temperature of the feed gas stream is at least about 500° C.

11. The method of claim 1 wherein the predetermined low pressure is between about 20 and 30 psig.

12. The method of claim 1 wherein expanding the heated gas stream produces electricity.

13. The process of claim 12 wherein the electricity is produced at a rate equivalent to at least about 20% of the heat of combustion of the fuel source combusted.

14. The process of claim 12 wherein the electricity is produced at a rate equivalent to at least about 35% of the heat of combustion of the fuel source combusted.

15. A preheating process for a regenerator in a fluid catalytic cracking system having a reactor and a regenerator at oxidative conditions, comprising:
compressing a first gas stream comprising oxygen and nitrogen at an inlet pressure to a second pressure to produce a compressed gas stream, wherein the ratio of the pressure of the compressed gas to the inlet pressure is between about 15:1 and 30:1;
combusting a second gas stream comprising a fuel source with the compressed gas stream to produce a heated gas stream, wherein the ratio of oxygen to fuel in the combustor is between about 2 and 3 times the stochiometric ratio;
expanding the heated gas stream to a predetermined low pressure to produce a feed gas stream at a temperature of at least about 300° C. and electricity; and
introducing the feed gas stream to the regenerator in the fluidized catalytic cracking system to burn coke from spent catalyst in the regenerator under oxidative conditions.

16. A preheating system for a regenerator in a fluidized catalytic cracking system, comprising:
a first gas comprising oxygen at an inlet pressure;
a compressor in fluid communication with the first gas and configured to compress the first gas to a pressure of at least about 10 atm;
a second gas comprising a fuel source;
a combustor in fluid communication with the compressor and the second gas and configured to combust the second gas with the first gas to produce a heated gas;
an expander in fluid communication with the compressor and configured to expand the heated gas to a predetermined low pressure to produce a feed gas at a temperature of at least about 300° C. and electricity; and
a regenerator for regenerating spent catalyst in fluid communication with the expander and configured to receive the feed gas to burn coke from the spent catalyst.

17. The system of claim 16 wherein the fuel source is natural gas.

18. The system of claim 16 wherein the fuel source is dry gas from the fluidized catalytic cracking unit.

19. The system of claim 16 wherein the oxygen source is air.

20. The system of claim 16 wherein the compressor, the combustor, and the expander are provided in a gas turbine engine.

21. A fluidized catalytic cracking system, comprising:
a reactor where hydrocarbon feed is contacted with a catalyst to crack the hydrocarbon feed and generate spent catalyst;
a first gas comprising oxygen at an inlet pressure;
a compressor in fluid communication with the first gas and configured to compress the first gas to a pressure of at least about 10 atm;
a second gas comprising a fuel source;
a combustor in fluid communication with the compressor and the second gas and configured to combust the second gas with the first gas to produce a heated gas;
an expander in fluid communication with the compressor and configured to expand the heated gas to a predetermined low pressure to produce a feed gas at a temperature of at least about 300° C. and electricity; and
a regenerator at oxidative conditions and configured to receive the spent catalyst from the reactor and the feed gas from the expander to burn coke from the spent catalyst.
